(19) United States
(12) Patent Application Publication
(10) Pub. No.: US 2009/0140027 A1
(43) Pub. Date: Jun. 4, 2009

(54) FRICTION STIR SPOT WELDING TOOL AND METHOD

(75) Inventors: Harsha Badarinarayan, Novi, MI (US); Qi Yang, Farmington Hills, MI (US); Frank Hunt, West Bloomfield, MI (US)

Correspondence Address: GIFFORD, KRASS, SPRINKLE,ANDERSON & CITKOWSKI, P.C, PO BOX 7021, TROY, MI, 48007-7021, US

(73) Assignee: Hitachi, Ltd, Tokyo (JP)

(21) Appl. No.: 11/948,088

(22) Filed: Nov. 30, 2007

(51) Int. Cl. B23K 20/12

(52) U.S. Cl. 228/114.5; 228/2.3

(57) ABSTRACT

A friction stir spot welding tool having a rotatably driven shank. A shoulder adjacent to one end of the shank is generally circular in shape having a concave profile while a pin having a generally triangular cross-sectional shape protrudes axially outwardly from the shoulder. To perform the spot welding operation, the shank is rotatably driven and the shoulder is plunged into the workpiece such that the pin penetrates past the workpiece interface to a predetermined depth to perform the spot weld.

The proposed triangular pin tool is found to significantly increase the weld strength when compared to conventional pin shaped tools due to the following: (1) it inhibits the formation of the vertical hook in the stir zone (the upward rise of the hook is arrested when the pin plunges into the workpieces interface), and (2) due to the asymmetric rotational pattern of the triangular pin it enhances the mixing of the material around the tool pin and oxide layer is dispersed (made discontinuous) in the stir zone.

### BACKGROUND OF THE INVENTION

I. Field of the Intention

The present invention relates generally to friction stir welding tools and methods and, more particularly, to a friction stir spot welding tool and method for friction stir spot welding.

II. Description of Related Art

Friction Stir Welding (FSW) is a solid-state welding process that uses a non-consumable rotating tool. A typical FSW tool consists of a cylindrical “shoulder” and another cylindrical region emanating from the shoulder called the “pin”. The process is initiated by plunging the rotating tool into the workpieces to be joined until the shoulder is in complete contact with the surface of the workpiece. The tool is then held for a few seconds wherein the material surrounding the tool is heated by friction and dissipation of plastic deformation. Subsequent to that, the tool is traversed along a specified path. The weld is formed by displacing the hot material around the pin and thereby eliminating the interface of the joining workpieces. Once the desired weld travel is completed, the tool traversing is stopped, and the tool is retracted back up. This is referred to as linear FSW and is considered a steady state process in which the tool reaches a steady state temperature, e.g. butt FSW, lap FSW etc.

In contrast to friction stir linear welding, friction stir spot welding (FSSW) is a transient process where the time required to perform the spot weld is so short that the tool does not reach a steady state temperature. FSSW secures two overlapped metal sheets by forming a metallurgical bond between the two sheets. The strength of the spot weld significantly depends upon the bonded area. Therefore, the key aspects of friction stir spot welding are the tool geometry and the weld process parameters.

For metallic materials, a thin oxide film is oftentimes present on the surface of the material. During welding, a “hook” line (an array of broken surface oxide) is formed because of the upward bending of the workpiece interface due to the tool penetration into the bottom sheet. At the end portion of the hook, oxide particles become dispersed, thus causing partial metallurgical bonding of the overlapped sheets. The hook geometry is related to the volume of the tool penetration through the interface of the two sheets that are being joined. The presence of oxide in the weld zone diminishes the integrity of the bonded region and thus significantly reduces the weld strength when the weld is subjected to external loading since the failure (crack propagation) occurs along the hook line.

With reference now to FIG. 5, a cross-sectional enlarged view of a spot weld using a conventional friction stir welding tool with a cylindrical pin is shown. The spot welding is used to secure a top metal sheet 20 to a bottom metal sheet 22. The top metal sheet 20 includes a thin metal oxide layer 26 on its bottom while, similarly, the bottom sheet 22 includes a thin metal oxide layer 24 on its top.

During a conventional friction stir spot welding operation utilizing a tool with a cylindrical pin, the cylindrical pin is plunged into the interface of the two sheets so that the pin forms a keyhole 28 extending between the two sheets 20 and 22. During the plunging of the cylindrical pin into the workpiece interface, a vertical hook line 32 begins to form and continues to rise till the pin reaches its predetermined plunge depth. However, due to the axis-symmetric geometry of the cylindrical pin, it has been observed that this vertical hook cannot be destroyed (dispersed) by further rotation of the tool. Furthermore, when the shoulder plunges into the surface of the top sheet, the hook only moves outward in the radial direction. Thus, using a cylindrical pin, the hook 32 is always present in the stir zone which diminishes the integrity of the weld between the sheets 20 and 22 when using a conventional circular pin tool.

Using conventional friction stir welding tools with cylindrical pins, the height of the hook h_{c} is relatively large so that the effective thickness t_{c} of the top sheet 20, i.e. the thickness between the top of the hook 32 and a top surface 34 of the top sheet 20, is relatively small. When the welded specimen is subjected to external loading (e.g. when welds are tested for their strength), the failure of the welds is imminent along the hook line and then through the top sheet because the resistance offered by the top sheet to the external loading is very small. This is primarily due to the fact that the effective thickness t_{c} of the top sheet 20 is the only geometrical feature that offers resistance to the external loading, and since t_{c} is very thin, it is easy to imagine that the strength of welds made with cylindrical tool will be quite low. This is the main reason why there is a need to develop a better tool geometry that will minimize the hook height and increase the effective thickness of the top sheet thereby improving joint strength.

### SUMMARY OF THE PRESENT INVENTION

The present invention provides a friction stir spot welding tool and method for using the spot welding tool which overcomes the above-mentioned disadvantages (such as presence of continuous oxide layer in the stir zone and a large hook height) of the previously known tools and methods.

Like the previously known friction stir spot welding tools, the spot welding tool of the present invention includes a shank having a rotatable axis and which is rotatably driven by a conventional rotary drive machine about its axis. A shoulder adjacent to one edge of the shank is generally circular in cross-sectional shape and plunges to a predetermined depth into the workpiece during a friction stir spot welding operation.

A pin extends axially outwardly from the shoulder such that the pin plunges into the workpiece (through the entire top sheet and partially into the second sheet) during the friction stir spot welding operation. Unlike the previously known tools, however, the pin is generally triangular in cross-sectional shape, rather than circular. As such, during the continued plunging of the shank and thus of the pin past the interface of the two sheets to be joined, the triangular pin provides enhanced intermixing of the metal between the upper and lower metal sheets. In addition, the hook formed during the tool penetration (with triangular pin) is closer to the keyhole as compared the hook formed with a conventional cylindrical pin tool. This is because the volume of a triangular pin is less than the volume of a cylindrical pin with both having the same diameter of the inscribed circle and same plunge depth. These two beneficial factors make the triangular pin tool more efficient in dispersing the hook within the stir zone as compared to the conventional cylindrical pin, thus resulting in a metallurgically sound weld and relatively low hook height. This consequently results in increasing the effective thickness of the top sheet. This, in turn, increases the strength of the spot welds and inhibits premature failure of the spot weld in peel, shear or other modes of fracture.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is a diagrammatic view illustrating the operation of the present invention;

FIG. 2 is an elevational view illustrating a preferred embodiment of a friction stir spot welding tool according to the present invention;

FIG. 3 is an axial plan view of the tool;

FIG. 4 is a sectional view taken substantially along line 4-4 in FIG. 2 and enlarged for clarity;

FIG. 5 is a prior art enlarged fragmentary sectional view illustrating a weld following a prior art friction stir spot welding operation;

FIG. 6 is a view similar to FIG. 5, but illustrating a spot weld utilizing the friction stir welding tool of the present invention;

FIG. 7 is an elevational view of a modification of the tool; and

FIGS. 8A-8E are end views illustrating modifications to the invention

### DETAILED DESCRIPTION OF A PREFERRED EMBODIMENT OF THE PRESENT INVENTION

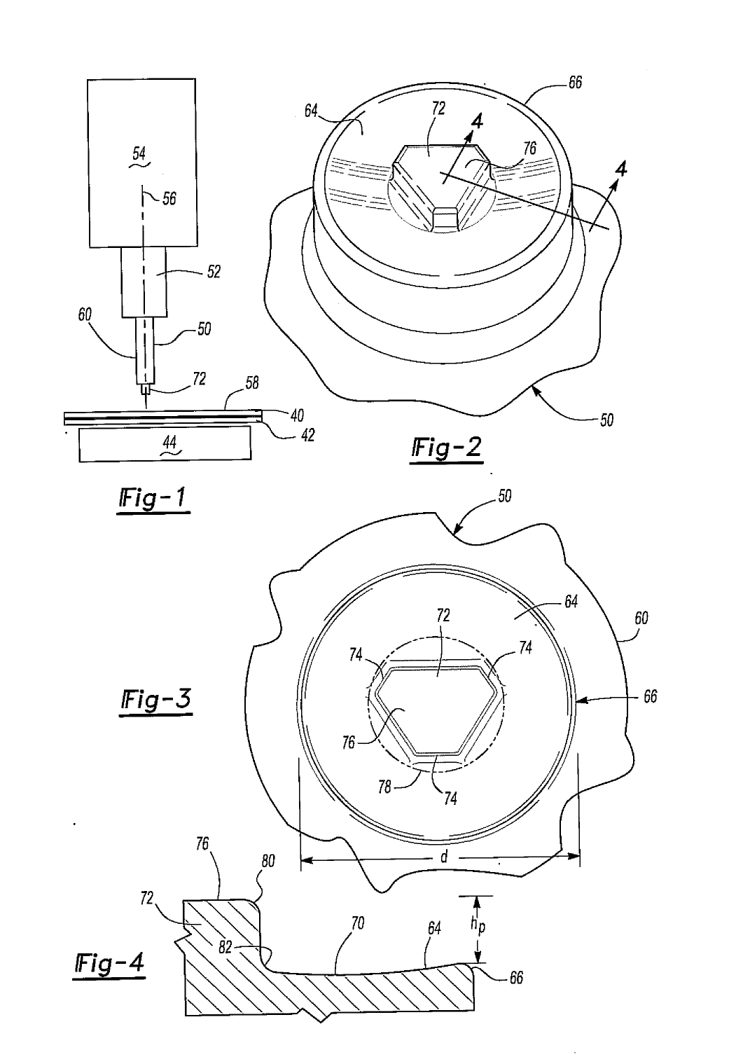

With reference first to FIG. 1, a diagrammatic view of a friction stir spot welding operation is shown for performing a spot weld between two metal sheets 40 and 42. These metal sheets 40 and 42 are typically made of a metallic material, such as aluminum, magnesium, steel, and the like are supported in some way against movement, such as by clamping the sheets 40 and 42 on a support 44.

A friction stir spot welding tool 50 according to the present invention includes an elongated shank 60 which is generally circular in cross section. The shank 60 is mounted by any conventional means, such as a chuck or tool holder 52, to a rotary drive machine 54. Upon activation of the rotary drive machine 54, the rotary drive machine 54 rotatably drives the tool 50 about its longitudinal axis 56. The rotational axis 56 of the tool 50, furthermore, is generally perpendicular to a top surface 58 of the top metal sheet 40.

With the rotary drive machine 54 rotatably driving the tool 50 at a high rotational speed, e.g. 2000 rpm, the tool 50 is plunged into the metal sheets 40 and 42. The continued rotation of the tool 50 for a relatively short period of time, e.g. 5 seconds, then performs the spot weld between the sheets 40 and 42 and the tool 50 is retracted from the workpiece or metal sheets 40 and 42.

As best shown in FIGS. 2-4, a circular shoulder 64 having a diameter d is axially aligned with the tool axis 56 and protrudes outwardly from the opposite end 70 of the shank 60. As best shown in FIG. 4, the shoulder 64 includes an outer fillet 66 which has a radius in the range of 0.03d to 0.05d. A concave surface 70 with an angle of concavity generally between 5 and 12 degrees is formed on the axially outwardly extending surface of the shoulder 64.

Although the shoulder 64 is shown as circular in shape, other shapes may be used without deviating from the spirit or scope of the invention. For example, the shoulder 64 may be square, polygonal or elliptical in shape.

Still referring to FIGS. 2-4, a pin 72 having a generally triangular shape when viewed in plan along the axis 56 of the tool 50 protrudes outwardly from the shoulder 64 coaxially with the tool axis 56. The pin preferably has three truncated vertices 74 wherein the length of each truncated vertex is in the range of 0.07d to 0.1d. The truncated vertices 74 advantageously reduce the amount of tool wear of the tool 50 after multiple friction stir spot welding operations; this is because in the absence of truncated edges, the sharp edges would wear more easily when successive spot welding operations are made. In addition, the wear on the three vertices may or may not be equal in magnitude, resulting in a tool that has a different geometry after welding than when it was started. This change in geometry could lead to undesirable results. Having a truncated vertex reduces this problem and tool wear is significantly reduced.

The overall height hp of the pin 72, i.e. the distance between the fillet 66 and a free end 76 of the pin 72, will vary depending upon the thickness of the two workpieces or sheets to be secured together. However, the height of the pin 72 is selected so that the free end 76 of the pin 72 extends into the lower sheet during the friction stir spot welding operation.

With reference now particularly to FIG. 3, an imaginary inscribed circle 78 is shown around the pin 72. The diameter of the imaginary circle 78 which encloses the pin 72 is in the range of 0.4d to 0.5d for optimum performance of the friction stir spot welding tool.

Referring now particularly to FIG. 4, in order to minimize wear and tear on the tool and increase tool life, a fillet 80 is provided along each edge at the outermost or free end of the pin 72. Similarly, another fillet 82 is also provided entirely around the pin 72 at its intersection with the shoulder 64. The diameter of each fillet 80 and 82 is in the range of 0.01d to 0.02d.

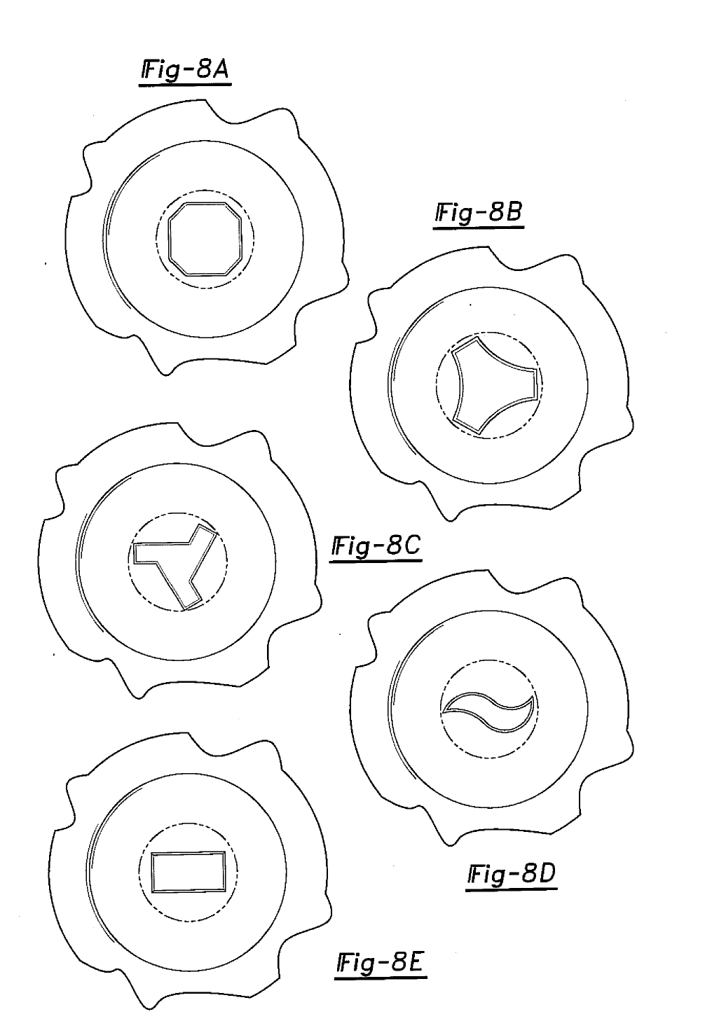

Although the pin 72 is preferably triangular in shape with truncated vertices, other non-circular pin shapes may alternatively be used. For example, the pin may be square with truncated corners as shown in FIG. 8A, delta shaped with truncated vertices as shown in FIG. 8B, lambda shaped as shown in FIG. 5C, curved paddle shaped as shown in FIG. 8D or rectangular with truncated corners as shown in FIG. 8E.

The pin 72, shoulder 64 and shank 60 are of a one-piece construction. Furthermore, the friction stir spot welding tool 50 is made of a hard material which is harder than the materials that are joined during a spot welding operation.

With reference now to FIG. 1, during a friction stir spot welding operation, the tool 50 is mounted within the tool holder 52 and rotatably driven by the rotary drive machine 54. While spinning, the tool 50 is plunged into the sheets 40 and 42 so that the pin 72 plunges into the sheets or workpiece 40, 42 and is spun for a relatively short period of time, e.g. 5 seconds. The tool 50 is then retracted from the workpiece 40, 42.

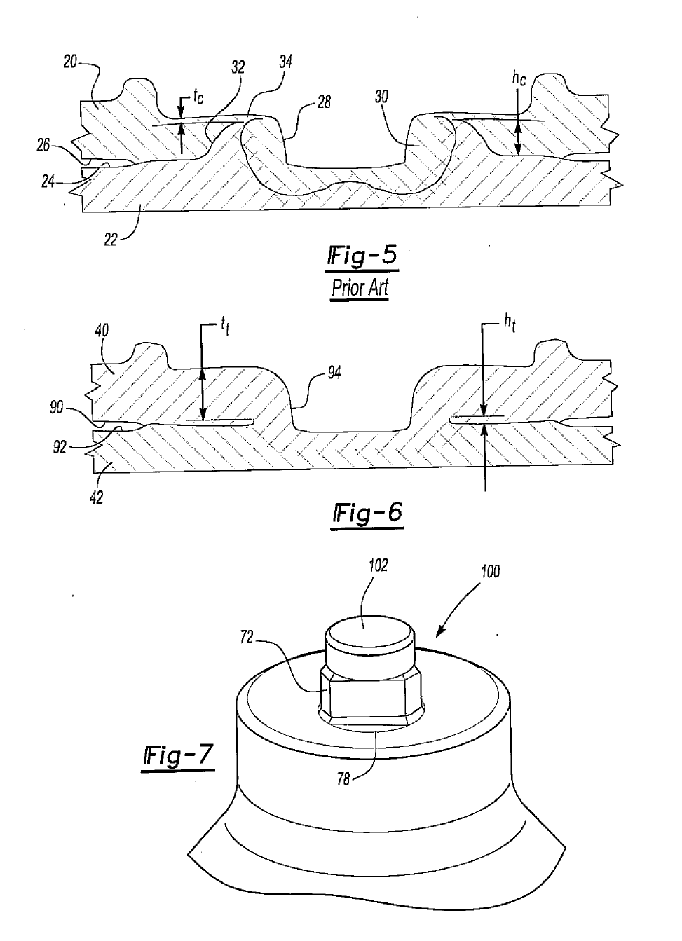

With reference now to FIG. 6, an exemplary cross section of the spot weld formed by the tool 50 is illustrated. In practice, the triangular shape of the pin 72 enhances the overall agitation of the metal of the sheets 40 and 42 during the stir spot welding operation as compared with the prior art friction stir welding tools with circular pins. Due to the asymmetric rotation of the triangular pin tool, as the pin plunges into the workpiece and the upward motion of the hook begins to be formed, the hook (oxide layer) is destroyed, i.e. dispersed, into the stir zone. This happens because when the triangular pin is rotating, close to the face of the pin, the material is always being pushed back and forth due to the paddling action caused by face of the triangular pin. Furthermore, since the hook is close to the keyhole, the material in this region is being “violently” mixed (churned), hence dispersing any continuous line of oxide that is present. This results in the elimination of any sharp hook that may be formed due to the plunging of the tool and, in turn, reduces the overall hook height ht and increases the effective thickness tₜ of the top sheet 40 following the spot weld. Since the effective thickness tₜ of the top sheet 40 is increased, the assembly formed by the two sheets 40 and 42 after the spot welding operation is much more resistant when subjected to external loading.

With reference now to FIG. 7, a hybrid friction stir spot welding tool 100 is illustrated in which a circular pin 102 having a diameter smaller than the imaginary diameter 78 extends outwardly from the pin 72. The circular pin 102 is optionally threaded. The main advantage of having threads on the pin is that it enhances material mixing (especially along the thickness direction) between the workpieces. The advantage of using threaded circular pins is more prominent when welding thick workpieces (e.g. thickness greater than 5 mm). Since it is difficult to machine threads on a triangular pin, a hybrid pin is proposed wherein the advantages of the circular pin 102, which may be externally threaded, together with the advantages of the triangular shaped pin 72, may be obtained in the formation of a friction stir spot weld, particularly for thick workpieces.

Still further modifications may be made without deviation from the spirit or scope of the invention. For example additional features, such as threads or grooves, may be machined on the sides of the pin to further enhance mixing of the metal during the spot weld. Similarly, asymmetric rotation of the tool may also create better metal mixing during a spot welding operation.

From the foregoing, it can be seen that the present invention provides a simple and yet effective friction stir spot welding tool, as well as a method for friction stir spot welding, which provides significant advantages over the previously known tools. Having described our invention, however, many modifications thereto will become apparent to those skilled in the art to which it pertains without deviation from the spirit of the invention as defined by the scope of the appended claims.

We claim:

1. A friction stir spot welding tool comprising:
a shank having a rotational axis,
a shoulder adjacent one end of said shank,
a pin having a non-circular cross-sectional shape protruding axially outwardly from said shoulder.

2. The invention as defined in claim 1 wherein said pin is generally triangular in shape.

3. The invention as defined in claim 2 wherein each vertex of said pin is truncated.

4. The invention as defined in claim 2 wherein said shoulder is circular in cross-sectional shape and has a diameter d and wherein a length of each truncated vertex is in the range of 0.07d to 0.10d.

5. The invention as defined in claim 2 wherein said shoulder has an axially outwardly facing concave surface.

6. The invention as defined in claim 5 wherein said concave surface has a concavity, generally in the range of 5-12 degrees.

7. The invention as defined in claim 2 wherein said pin includes a fillet along each side at a free end of said pin.

8. The invention as defined in claim 7 wherein said shoulder is circular in cross-sectional shape and has a diameter d and wherein a radius of each fillet is in the range of 0.01d to 0.02d.

9. The invention as defined in claim 2 wherein an outer edge of said shoulder at the free end of said shoulder includes a fillet.

10. The invention as defined in claim 9 wherein said shoulder is circular in cross-sectional shape and has a diameter d and wherein a radius of said fillet is in the range of 0.03d to 0.05d.

11. The invention as defined in claim 2 wherein said pin includes a fillet along each side at an intersection of said shoulder and said pin.

12. The invention as defined in claim 11 wherein said shoulder is circular in cross-sectional shape and has a diameter d and wherein a radius of each fillet is in the range of 0.01d to 0.02d.

13. The invention as defined in claim 2 and comprising a circular pin attached to and extending coaxially outwardly from said generally triangular shaped pin.

14. The invention as defined in claim 13 wherein said pin is externally threaded.

15. The invention as defined in claim 2 wherein said shoulder is circular in cross-sectional shape and wherein an imaginary circle in said pin has a diameter in the range of 0.4d to 0.5d.

16. A method for performing a spot weld in a workpiece comprising the steps of:
rotatably driving a tool about a rotational axis, said tool having a shank with an axis aligned with said rotational axis, a shoulder adjacent one end of said shank, said shoulder being circular in cross-sectional shape, and a pin having a non-circular cross-sectional shape protruding axially outwardly from said shoulder,
plunging the tool into the workpiece so that said pin penetrates the workpiece.

17. The invention as defined in claim 16 where in said pin is generally triangular in shape.

18. The invention as defined in claim 17 wherein each vertex of said pin is truncated.

19. The invention as defined in claim 17 wherein said shoulder is circular in cross-sectional shape and has a diameter d and wherein a length of each truncated vertex is in the range of 0.07d to 0.10d.

20. The invention as defined in claim 17 wherein said shoulder has an axially outwardly facing concave surface.

21. The invention as defined in claim 20 wherein said concave surface has a concavity, generally in the range of 5-12 degrees.

22. The invention as defined in claim 17 wherein said pin includes a fillet along each side at a free end of said pin.

23. The invention as defined in claim 22 wherein said shoulder is circular in cross-sectional shape and has a diameter d and wherein a radius of each fillet is in the range of 0.01d to 0.02d.

24. The invention as defined in claim 17 wherein an outer edge of said shoulder at the free end of said shoulder includes a fillet.

25. The invention as defined in claim 24 wherein said shoulder is circular in cross-sectional shape and has a diameter d and wherein a radius of said fillet is in the range of 0.03d to 0.05d.

26. The invention as defined in claim 17 wherein said pin includes a fillet along each side at an intersection of said shoulder and said pin.

27. The invention as defined in claim 26 wherein said shoulder is circular in cross-sectional shape and has a diameter d and wherein a radius of each fillet is in the range of 0.01d to 0.02d.

28. The invention as defined in claim 17 wherein said shoulder is circular in cross-sectional shape and wherein an imaginary circle in said pin has a diameter in the range of 0.4d to 0.5d.
